(19) United States
(12) Patent Application Publication
(10) Pub. No.: US 2026/0141264 A1
(43) Pub. Date: May 21, 2026

(54) DELIVERING DOMAIN-EXPERT AGENTS AND MODELS USING SYNTHETIC KNOWLEDGE

(71) Applicant: Aitomatic, Inc., Cupertino, CA (US)

(72) Inventors: Christopher Nguyen, Los Altos, CA (US); Manh-Nguyen Nguyen, Palo Alto, CA (US); Hong An Phan, San Jose, CA (US); Zooey Nhu-Quynh Nguyen, Los Altos, CA (US); The-Vinh Luong, San Jose, CA (US); Elise Nhu-Y Nguyen, Los Altos, CA (US); Thomas Rasmussen, Palo Alto, CA (US); Anh Hai Ha, Sunnyvale, CA (US); Phi-Hung Vo, Ho Chi Minh City (VN); Xuan-Sang Dinh, Ho Chi Minh City (VN); Hyu-Thuan Bui, Ho Chi Minh City (VN); Anh-Quoc Dang, Ho Chi Minh City (VN)

(21) Appl. No.: 19/391,976

(22) Filed: Nov. 17, 2025

Related U.S. Application Data
(60) Provisional application No. 63/721,419, filed on Nov. 15, 2024.
(60) Provisional application No. 63/726,322, filed on Nov. 28, 2024.

(51) Int. Cl. G06N 5/02

(52) U.S. Cl. CPC G06N 5/02

(57) ABSTRACT

A system generates domain-expert agents for a particular domain. The system generates a hierarchy of topics for the domain by forming structured query inputs and requesting a machine learning-based language model to produce topics and associated sets of search terms. A knowledge store is built for the domain by identifying, for each topic, facts represented symbolically and/or in natural language. For at least one topic, programs comprising instructions for executing domain-specific procedures are generated and stored as symbolic and/or natural language programs. The knowledge store is evaluated to determine an expertise level for a domain-expert agent. If the knowledge store meets a threshold of knowledge, a deployment package is created comprising the knowledge store, and the domain-expert agent is deployed. The deployed agent utilizes the knowledge store together with a machine learning language model to address and solve problems specific to the domain.

### CROSS REFERENCE TO RELATED APPLICATION

This application claims priority to U.S. Provisional Patent Application Ser. No. 63/721,419, filed on Nov. 15, 2024, and U.S. Provisional Patent Application Ser. No. 63/726,322, filed on Nov. 28, 2024, each of which is herein incorporated by reference in its entirety.

### FIELD OF INVENTION

The disclosure relates in general to artificial intelligence and machine learning techniques combining neural-network processing with symbolic processing, and delivering domain-expert agents for improving problem solving.

### BACKGROUND

Artificial intelligence (AI) agents have become increasingly capable of performing tasks across various domains, driven by advances in machine learning based language models, particularly large language models (LLMs). These agents can process unstructured text, generate natural language responses, and support decision-making in a variety of contexts. LLMs have shown promise by generating information across diverse domains, but their inherent probabilistic nature often leads to inconsistency and inaccuracy in complex problem-solving tasks. LLMs have been successfully used for tasks whose results can be open-ended, such as internet research, creative content creation, and certain types of analysis. The inaccuracies and non-deterministic nature of LLMs as well as issues such as hallucinations make LLMs not suitable for specialized domains such as industrial tasks where precision, accuracy, and depth of knowledge is required. For example, repeated execution of an LLM for identical input may result in different outputs being generated. Such unpredictability in the results generated make them less suitable for use in mission critical applications. Furthermore, LLMs are resource intensive and time intensive making their use for complex tasks impractical or expensive in terms of resource usage.

### SUMMARY

A domain-expert agent is generated and deployed for solving domain-specific problems using a combination of curated knowledge and machine learning based models. The steps disclosed herein are performed by a system which can be an agent builder system or a domain-expert agent. The system receives information describing a selected domain. A hierarchy of topics is created by generating structured query inputs for a machine learning-based language model, which returns topics and associated search terms relevant to the domain. A knowledge store is constructed by identifying, for each topic, facts represented either as symbolic knowledge structures or as natural language statements. For some topics, programs comprising executable instructions for performing domain-specific procedures are generated, with such programs stored either symbolically or in natural language form. The system evaluates the knowledge store to determine the expertise level of a candidate domain-expert agent. If the knowledge store meets or exceeds a defined threshold of completeness or sophistication, a deployment package containing the knowledge store is assembled. This package is used to deploy the domain-expert agent. The deployed agent leverages the knowledge in the knowledge store, together with the machine learning language model, to solve domain specific problems.

Various embodiments disclosed herein relate to additional features and operations of a computer-implemented system and method for implementing a domain-expert agent trained to solve domain-specific problems.

According to some embodiments, the system receives a context associated with a domain-specific problem, identifies tuples of facts within the knowledge store relevant to that context, generates a structured query input based on the context and relevant facts, and obtains a solution from a response generated by executing a machine learning-based language model.

According to some embodiments, the system determines whether a program stored in the knowledge store can be applied to solve a given domain-specific problem by comparing a description of the problem context with descriptions of stored programs. Such determination may include generating or storing vector representations of program descriptions in a vector database, determining a vector representation of the context, and computing vector distances between the context representation and stored program representations. Additionally, the determination may involve verifying that the problem context can provide values for all input parameters required by a candidate program.

According to some embodiments, upon determining that a program stored in the knowledge store can address the domain-specific problem, the agent executes the program to generate a solution. In further embodiments, if no stored program is suitable, the agent may generate a new program by formulating a structured query describing the problem context, obtaining a program from a machine learning-based language model in response to that query, storing the new program in the knowledge store, and executing it to solve the problem.

According to some embodiments, the knowledge store is populated with facts, including facts obtained directly from a domain expert user via chatbot interaction, or by performing searches for documents related to topics in the domain based on associated search terms, followed by processing the documents to extract relevant facts.

According to some embodiments, the system determines whether context information is structured or unstructured. When the context comprises structured data, the system may utilize symbolic programs and symbolic facts to generate a solution. When the context comprises unstructured data, the system may instead utilize natural language programs and natural language facts.

Some embodiments further comprise evaluating the knowledge store to determine an expertise level for the domain-expert agent. Such evaluation may involve collecting information describing user profiles of domain experts for the domain, generating multiple domain-specific questions based on the profiles, using a test domain-expert agent with the current knowledge store to answer the questions, and computing an aggregate metric representing the agent's expertise level based on the responses.

Embodiments perform steps of the methods disclosed hereon. Embodiments include computer readable storage media storing instructions for performing the steps of the above method. Embodiments include computer systems that comprise one or more computer processors and a computer readable storage medium store instructions for performing the steps of the above method.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 shows the overall system environment for building and deploying domain-expert agents, in accordance with an embodiment of the invention.

FIG. 2 shows the system architecture of an agent builder system, in accordance with an embodiment.

FIG. 3 illustrates the flow of data in an agent builder system, according to an embodiment.

FIG. 4A illustrates the flow of data in an agent builder system using manual capture, symbolic knowledge and symbolic programs, according to an embodiment.

FIG. 4B illustrates the flow of data in an agent builder system using automatic capture, symbolic knowledge and symbolic programs, according to an embodiment.

FIG. 4C illustrates the flow of data in an agent builder system using manual capture, natural language knowledge and natural language programs, according to an embodiment.

FIG. 4D illustrates the flow of data in an agent builder system using automatic capture, natural language knowledge and natural language programs, according to an embodiment.

FIG. 5 illustrates the overall process for collecting domain specific knowledge for a domain-expert AI agent, according to an embodiment of the invention.

FIG. 6 is a high-level block diagram illustrating an example system, in accordance with an embodiment.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### DETAILED DESCRIPTION

The system implements DANA (Domain-Aware Neurosymbolic Agent), an architecture that addresses these challenges by integrating domain-specific knowledge with neurosymbolic approaches. DANA incorporates domain expertise in both natural-language and symbolic forms, enabling more deterministic and reliable problem-solving behaviors. The system is able to use domain-aware neurosymbolic agents for tackling complex, real-world problems that require precision and reliability.

The system builds domain-expert agents (DXA) that are domain-experts and have domain specific knowledge. These domain-expert agents may be provided to tenants or customers for use in the field/production. Therefore, a customer gets a domain-expert agent delivered out of the box rather than an agent without any expertise that needs to build all the domain knowledge starting from scratch. This is similar to delivering a skilled agent (akin to a graduate level person with qualifications in the field of employment) as opposed to a novice agent (akin to a high school student with basic skills need to acquire the domain knowledge but not already equipped with the domain knowledge). This provides a significant head start when deploying the agents in the field, thereby allowing the agent to perform at a much higher degree of accuracy and efficiency in learning further.

According to an embodiment, the system prepopulates the agent with (1) general knowledge that may not be specific to a domain; and (2) domain specific knowledge. The system synthesizes domain specific knowledge and incorporates the domain specific knowledge in the agent. An agent includes components comprising (1) facts, rules, and heuristics collection and (2) program collection (or store).

The knowledge may be provided to the agent as one or more of the following: (1) by incorporating the domain specific knowledge in a machine learning based model that is invoked by the agent; (2) facts, rules, and heuristics that may be stored in a facts, rules, and heuristics store; and (3) a program store that stores programs representing instructions for performing specific procedures to solve domain specific problems.

An agent may be made knowledgeable about a domain by providing knowledge using one or more of these mechanisms. The system performs automated capture to populate the above stores with domain specific knowledge. This allows the system to provide domain-expert agents that are prepopulated with domain knowledge so that the agent has less to learn when it is deployed in a domain specific field for which the agent is prepared.

The system according to various embodiments implements a “model using agent” (MUA) architecture. The system builds domain-expert agents and models using synthetic knowledge generated using LLMs. This is distinct from a model using human architecture where a human uses a model to solve problems and the planning & reasoning is performed by the human.

### System Environment

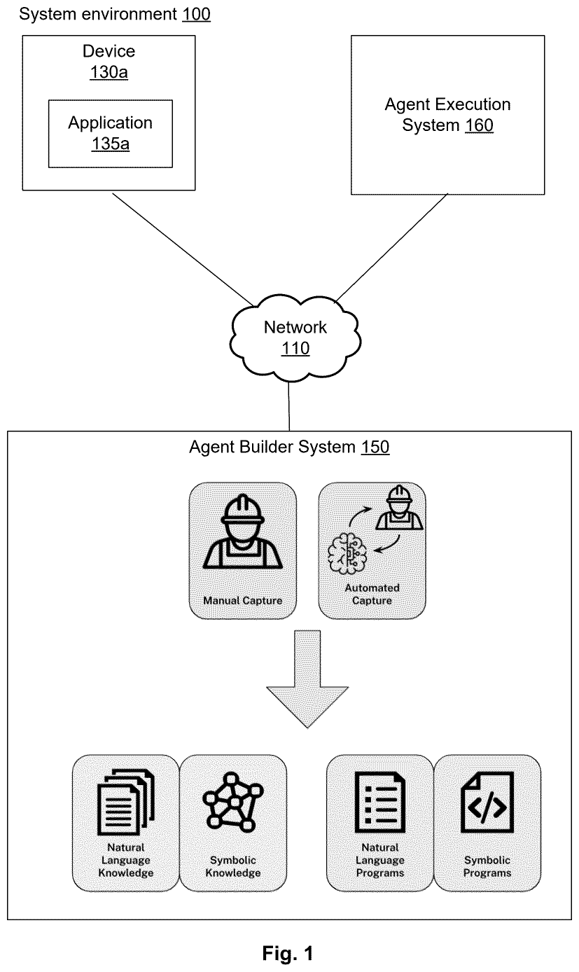

FIG. 1 shows the overall system environment for building and deploying domain-expert agents, in accordance with an embodiment of the invention. The overall system environment includes one or more devices 130, an agent builder system 150, an agent execution system 150, and a network 110. Other embodiments can use more or less or different systems than those illustrated in FIG. 1. Functions of various modules and systems described herein can be implemented by other modules and/or systems than those described herein.

The agent builder system 150 builds domain-expert agents. Accordingly, each domain-expert agent built is specialized to solve problems for a particular domain. The agent builder system 150 collects domain specific knowledge and stores it. The domain specific knowledge is packaged with the domain-expert agent. The agent builder system 150 may perform manual capture of knowledge or automated capture of knowledge for that particular domain. The agent builder system 150 stores the knowledge captured as facts and rules or as programs. The facts may be stored as natural language representation of knowledge or as symbolic representation of knowledge. The programs may be stored as natural language programs or as symbolic programs.

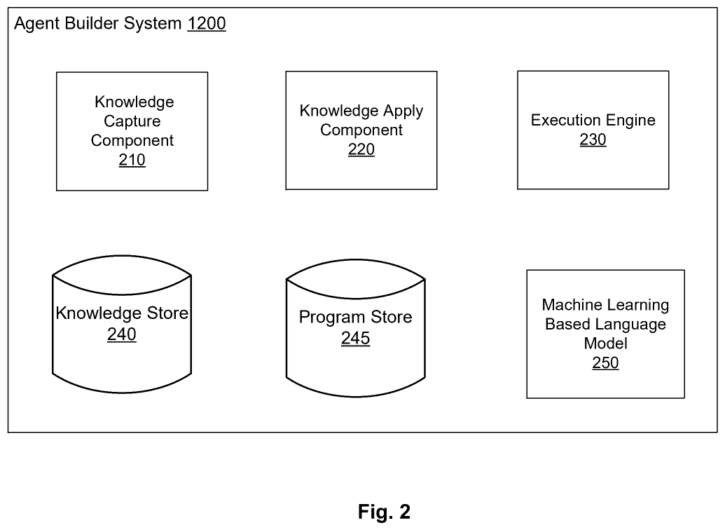

The knowledge based artificial intelligence system 150 allows experts to configure rules for making predictions related to a system. The knowledge based artificial intelligence system 150 further generates models, for example, machine learning models for making predictions. The knowledge based artificial intelligence system 150 combines results of the rule based systema and machine learning base system to make predictions. Further details of the knowledge based artificial intelligence system 150 are illustrated in FIG. 2 and described in connection with FIG. 2.

FIG. 1 and the other figures use like reference numerals to identify like elements. A letter after a reference numeral, such as “130a,” indicates that the text refers specifically to the element having that particular reference numeral. A reference numeral in the text without a following letter, such as “130,” refers to any or all of the elements in the figures bearing that reference numeral (e.g., “130” in the text refers to reference numerals “130” and/or “130” in the figures).

In an embodiment, the devices 130 are client devices used by users to interact with the agent builder system 150. The users of the devices 130 include experts that configure the agent builder system 150. In an embodiment, the device 130 executes an application 135 that allows users to interact with the agent builder system 150. For example, the application 135 executing on the device 130 may be an internet browser that interacts with web servers executing on the agent builder system 150.

Systems and applications shown in FIG. 1 can be executed using computing devices. A computing device can be a conventional computer system executing, for example, a Microsoft™ Windows™-compatible operating system (OS), Apple™ OS X, and/or a Linux distribution. A computing device can also be a client device having computer functionality, such as a personal digital assistant (PDA), mobile telephone, video game system, etc.

The interactions between the devices 130 and the agent builder system 150 are typically performed via a network 110, for example, via the internet. In one embodiment, the network uses standard communications technologies and/or protocols. In another embodiment, the various entities interacting with each other, for example, the knowledge based artificial intelligence system 150 and the devices 130 can use custom and/or dedicated data communications technologies instead of, or in addition to, the ones described above. Depending upon the embodiment, the network can also include links to other networks such as the Internet.

### System Architecture

FIG. 2 shows the system architecture of an agent builder system, in accordance with an embodiment. The agent builder system 120 comprises a knowledge capture component 210, a knowledge apply component 220, an execution engine 230, a knowledge store 240, a program store 245, and a machine learning based language model 250. In other embodiments, the knowledge first system 120 may include more or fewer modules than those shown in FIG. 2. Furthermore, specific functionality may be implemented by modules other than those described herein. In some embodiments, various components illustrated in FIG. 2 may be executed by different systems. Furthermore, the various models of the knowledge first system 120 may be executed using a parallel or distributed architecture for faster execution.

The knowledge capture component 210 allows the system to retain important domain-specific expertise to help achieve consistent and accurate problem-solving. The knowledge apply component 220 allows the system to perform program search and execution to solve problems. The execution engine 230 performs the program execution to achieve consistency and accuracy.

The knowledge capture module 210 module is responsible for extracting expert knowledge (or domain knowledge) from subject matter experts in a conversational format. The module may use natural language processing (NLP) techniques to understand the knowledge being provided by the subject matter experts and work with them to arrive at a complete and accurate form of their knowledge. Users may upload documents storing domain specific knowledge to the libraries, for example, PDF documents, text files, doc files, and so on. This module, having access to existing knowledge within the catalog, would be enabled to understand the domain of the expert and actively seek to (A) extract further, more complete, information, and (B) actively collaborate with the expert to make the knowledge complete and/or correct. According to an embodiment, the knowledge capture module 1210 is a chatbot trained to perform conversations with domain experts and ask questions for extracting information from the domain experts. According to an embodiment, the knowledge extracted is stored in a vector database, for example, GPT Index, or Langchain™. The vector database allows relevant portions of the knowledge stored to be extracted for answering domain specific questions based on the domain knowledge extracted. According to an embodiment, the knowledge capture module 210 performs conversations with a user and builds a summary of the conversation, for example, by providing the conversation to a large language model in one or more prompts and requesting the large language model (LLM) to summarize the conversation with the domain expert and using the response of the LLM as the summary of the conversation. Accordingly, the knowledge capture module 210 allows the system to use LLMs to convert natural language based domain specific knowledge obtained from one or more users and convert the knowledge into structure data that is stored in library, for example, a vector database. The system builds domain specific models (e.g., domain specific LLMS) using the knowledge stored in the library.

The knowledge capture component 210 determines whether information received is (a) fact, (b) rule or (c) program. The knowledge capture component 210 stores the collected information in the knowledge store 240 and program store 245. The knowledge capture component 210 and the knowledge store 240 may represent a fact as a triple comprising (i) an entity, (ii) a property of the entity, and (iii) a value of the property.

A rule may be a conditional inference rule that has a condition and one or more other facts that are likely to be true if the condition evaluates to true. The rules may represent domain specific knowledge captured from experts. Accordingly, a rule indicates that if a condition is true, certain fact F has a high likelihood of being true, and if the condition evaluates to false, the fact F has a high likelihood of being false. As an example, in an industrial context, a rule may specify (1) a condition that checks whether the temperature exceeds a threshold value and (2) one or more facts that are likely to be true if the temperature exceeds the threshold value, such as particular equipment being broken. The additional facts help the system with inference since the system has additional facts to arrive at specific conclusions and perform specific tasks/processes. A rule may be represented using natural language or as relations based on a specific syntax.

A program is a step-by-step, hierarchical, or another symbolic representation of analyses or actions to perform to solve a problem.

The knowledge apply component 220 among various other tasks, determines whether to match each stored program with a given context and what fact and rule to utilize for executing a program. According to an embodiment, the knowledge apply component performs program search and program execution. The program search step comprises finalizing the program to execute for solving the problem at hand, for example, by attempting to find an appropriate program that was previously stored or creating a new program if none of the stored programs are applicable. The program execution step involves retrieving and utilizing relevant captured facts and rules to run a chosen program for problem-solving.

The execution engine 230 among various other tasks, determines whether to use symbolic pattern match or neural network based match and proceeds with the right execution. The execution engine executes a program finalized for solving the current problem. The facts and the rules are applied during the execution step. While executing the program, the system retrieves relevant facts (or knowledge or information) or rules that need to be applied to execute a particular step of the program. Accordingly, the knowledge captured is applied in the execution process.

According to an embodiment, the agent builder system 150 packages the AI agent and deploys it at a target system, for example, the agent execution system 160. The agent execution system 160 includes the components knowledge apply component 220 and execution engine 230.

The machine learning based language model 250 may also be referred to herein as a large language model (LLM). In one embodiment, an LLM is trained on a large corpus of training data to process natural language requests. An LLM may be trained on large amounts of text data, often involving billions of words or text units. An LLM may be trained on a large amount of data from various data sources. For example, the data sources include websites, articles, posts on the web, and the like. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

In one instance, the LLM may be trained and deployed or hosted on a cloud infrastructure service. In one embodiment, the LLM has a generative pre-training (GPT) architecture including a set of decoders that each perform one or more operations to input data to the respective decoder. In another embodiment, the LLM has a transformer architecture that includes a set of encoders coupled to a set of decoders. While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM may be executed in a different component that provides the LLM as a web service. The agent builder system 150 may interact with the server running LLM as a web service using APIs of the web service. Accordingly, the agent builder system 150 sends a request specifying a prompt, also referred to as a structured query input to the LLM and receives a response comprising the result of execution of the LLM for the structured query input.

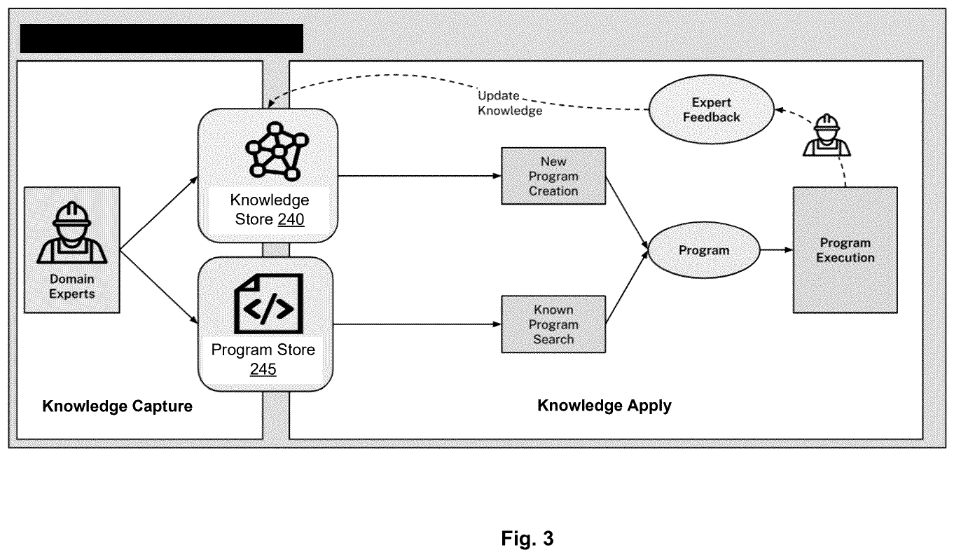

FIG. 3 illustrates the flow of data in an agent builder system, according to an embodiment. The system comprises a knowledge capture phase and a knowledge apply phase. The knowledge capture phase obtained data from a source, for example, domain experts. The knowledge captured is stored in knowledge store 240 and program store 245. The knowledge apply phase may search for known programs to execute for a given context and if no existing programs are applicable, creates new programs. The programs are executed and expert feedback is provided based on the execution to update the knowledge stored in knowledge store 240.

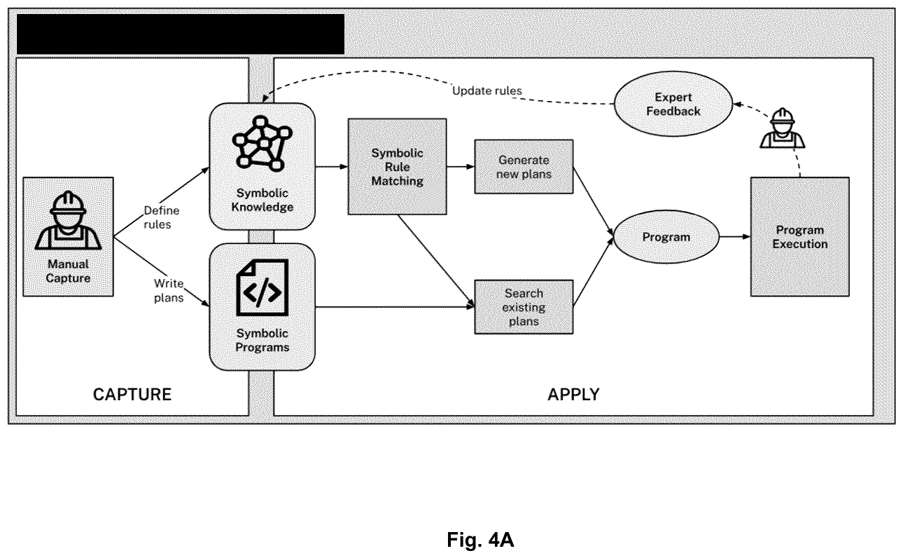

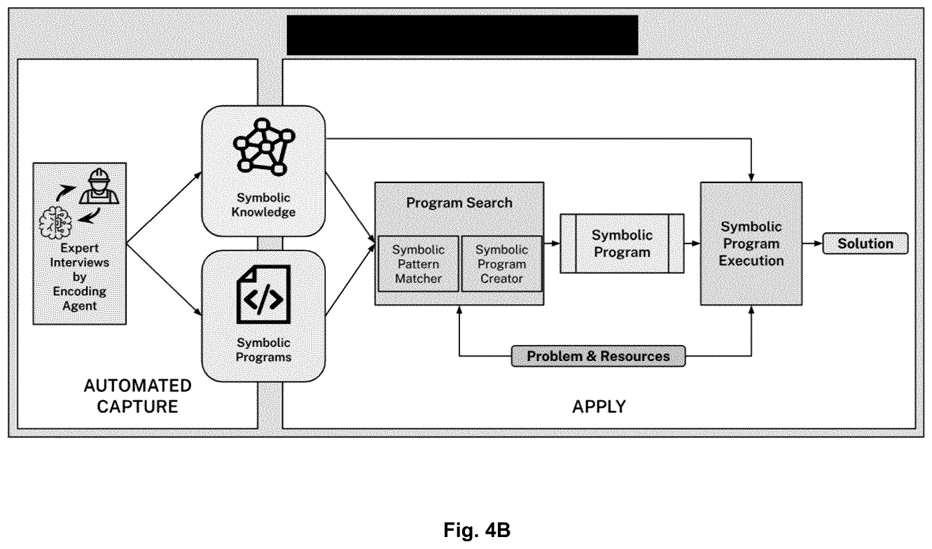

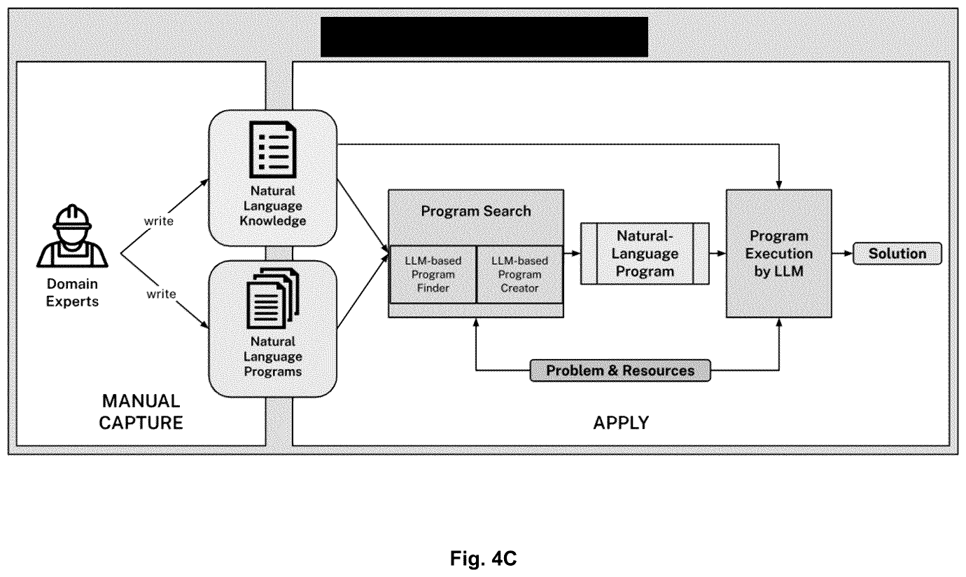

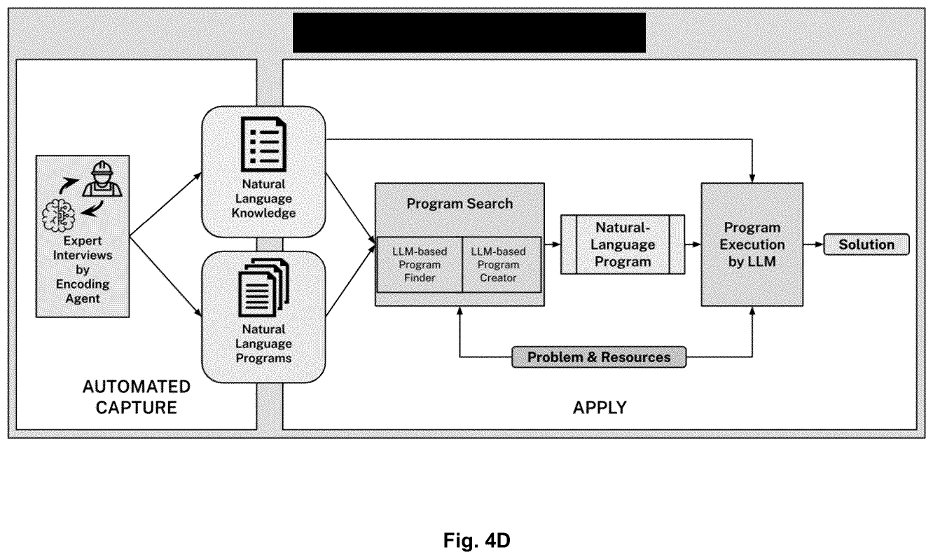

FIG. 4A illustrates the flow of data in an agent builder system using manual capture, symbolic knowledge and symbolic programs, according to an embodiment. The system shown in FIG. 4A performs manual capture in which domain experts or AI engineers directly input knowledge and programs. The knowledge captured is symbolic knowledge and symbolic programs. The existing programs, facts, and rules are identifying by symbolic matching and if no existing programs are found in the program store 245, new programs are generated.

FIG. 4B illustrates the flow of data in an agent builder system using automatic capture, symbolic knowledge and symbolic programs, according to an embodiment. The system shown in FIG. 4B performs automatic capture, for example, an agent such as a knowledge encoding assistant interviews domain experts and automatically encodes their knowledge and problem-solving strategies. The agent may also perform searches through knowledge repositories or Internet to collect knowledge including facts, rules, and programs.

FIG. 4C illustrates the flow of data in an agent builder system using manual capture, natural language knowledge and natural language programs, according to an embodiment. The system shown in FIG. 4C performs manual capture and stores natural language knowledge including facts and rules and natural language programs. The search for programs is performed using LLMs and new programs are created using LLMs. Natural language programs are executed using LLMs.

FIG. 4D illustrates the flow of data in an agent builder system using automatic capture, natural language knowledge and natural language programs, according to an embodiment. The system shown in FIG. 4D performs automated capture by interviewing domain experts automatically using agents.

Although the embodiments disclosed in FIGS. 4A-4D show different techniques, other embodiments can combine these techniques, for example, a system may perform both manual capture and automatic capture and store both symbolic knowledge and symbolic programs as well as natural language knowledge and natural language programs.

### Processes

The agent builder system 150 builds domain-expert models by performing the following steps: Step M1: Generate training data (TD) using an LLM; Step M2: Fine-tune model with TD; Step M3: Generate evaluation data (ED) using an LLM; Step M4: Evaluate model with ED; Step M5: Repeat from step M1.

The agent builder system 150 builds domain-expert agents by performing the following steps: Step A1: Generate prior knowledge (PK) using an LLM; Step A2: Inject PK into agent; Step A3: Generate evaluation data (ED) using an LLM; Step A4: Evaluate agent with ED; Step A5: Repeat from step A1.

The details of step M1 are as follows. The system performs pre-training of the of the model as part of step M1. The pretraining may be performed using pure-text data gathered from different sources including: (1) Open books (2) Open research papers and (3) Open web-text data. The system may perform supervised fine tuning (SFT).

The system performs question generation. The system performs practical question generation. This includes following steps: (1) Scenario generation: In this step, based on the role of experts the system needs to train, the system generates the working scenarios for this expert. This makes the generated questions become more specific and realistic. (2) The system uses the generated scenario as the condition to generate the question under the point of view of an engineer who needs to ask experts: practical questions in daily work; and technical questions that require math-based computation to answer.

The system also performs theory question generation: (1) the system generates questions about definitions that the expert might know; (2) the system generates the theory questions that require reasoning to answer.

The system further performs answer generation: (1) The system interprets and analyzes the question from the expert's perspective. (2) Based on the question, interpretation, and analysis, the system creates an actionable answer to support the engineers. The system primarily uses the actionable answers for training.

The system generates prompts requesting the machine learning based language model 250 to generate questions and answers and sends the prompts to the machine learning based language model 250 to obtain the responses and extract the questions and corresponding answers from the responses. Following is an example, pair of question and answer: Question: “I've encountered micromasking during my etching process. Could plasma density variations be contributing to this, and what parameters should I adjust to minimize micromasking?” Answer: “Micromasking during an etching process can indeed be influenced by plasma density variations. Here's a step-by-step guide to addressing this issue:\n\nl. **Diagnose Plasma Uniformity**:\n—**Check Plasma Density**: Use a Langmuir probe or an endpoint detection system to measure the plasma density across the wafer surface . . . and change one variable at a time to identify its impact on the micromasking and iteratively adjust based on your observations. Testing and optimization should be done carefully to avoid undesirable effects on other characteristics like etch rate and profile.”

The step M2 represents model training using standard techniques. The step M3 represents generation of evaluation data which is based on steps similar to those described in connection with step M1.

The step M4 performs evaluation of the model. The system can perform model evaluation using following techniques.

The following process is performed to gather knowledge from various knowledge sources including experts and various sources on the Internet. The knowledge capture component 210 determines whether some information received from an expert is (1) fact, (2) rule or (3) program. The system stores the three types of information in different formats and processes them differently.

The knowledge capture component 210 performs the following steps repeatedly. The knowledge capture component 210 presents a question to an expert, for example, via a user interface such as a chatbot. The knowledge capture component 210 receives an answer from the expert. The knowledge capture component 210 determines whether the information received from the expert represents a fact, rule or program. The knowledge capture component 210 stores the information in the knowledge store 240 and program store 245. If the knowledge capture component 210 determines that the information is a fact, the knowledge capture component 210 stores the fact with appropriate metadata in knowledge store 240. If the knowledge capture component 210 determines that the information is a rule, the knowledge capture component 210 stores the rule with appropriate conditional structure and other metadata in the knowledge store 240. If the knowledge capture component 210 determines that the information is a program, the knowledge capture component 210 stores appropriate metadata of program along with distinct steps of or code for that program in the program store 245.

The knowledge capture component 210 determines whether the information received from the expert represents a fact, rule or program as follows. According to an embodiment, the knowledge capture component 210 uses a machine learning model trained to receive information as input and predicts a score indicating whether the input is fact, rule or program. According to an embodiment, the agent builder system 150 fine tunes an LLM for the interview task. The agent builder system 150 creates fine-tuned LLMs and/or AI agents for recognizing and structuring facts, rules and programs in domain-specific formats.

The knowledge store 240 stores the various types of information as follows. The knowledge store 240 uses a representation of a fact in a generic form, i.e., a fact is a known quality or quantity related to a topic or entity of interest in a certain domain. The knowledge store 240 uses a format to capture a wide variety of facts that are possible, for example, using natural-language statements or using structured symbolic forms such as logic relations. The knowledge store 240 stores metadata along with the facts. For example, the metadata may include a topic or entity of interest and the name of the quality or quantity being measured or evaluated.

The knowledge store 240 stores a rule using a rule representation comprising a condition and actions, for example, using an if-then format such as “IF <this is true> THEN <that is (un)likely to be true>.” The knowledge store 240 may store rules as either (1) natural language statements or as (2) logic relations. The agent builder system 150 captures the rules by an interviewing AI agent posing scenarios in the domain in which a certain operating condition holds true, and asking an expert, given that condition, which other conditions are highly likely or unlikely.

The program store 245 stores programs as follows. Metadata stored with a process describing the purpose(s) or problem statement(s) for which the program can be used. The representation of a program comprises a sequence of steps, each step specified as natural language text, or a programming-code function or script. Accordingly, the representation of a program stored in the program store 245 can comprise (1) Natural-language instructions; (2) A hierarchical tree structure representing how major problems/tasks are decomposed into simpler/smaller ones, and the sequence of resolving those in order to resolve the major problems/tasks; or (3) A programming-language function or script.

If the knowledge capture component 210 determines that the information being extracted from a source represents a program, the knowledge capture component 210 performs following steps to extract the information from the source. The knowledge capture component 210 processes a series of questions presented to identify distinct steps of the program. If the knowledge source is an expert the knowledge capture component 210 asks the questions to the expert using a user interface, for example, a chatbot. If the knowledge source is a document, the knowledge capture component 210 provides the document to the machine learning based language model 250 and generates a structured query input for the machine learning based language model 250 with the question to generate an answer by executing the machine learning based language model 250. Accordingly, the expert can be a user or one or more documents processed using the machine learning based language model 250. More specifically following steps are performed to extract information from a data source: (1) An AI agent poses problem-solving scenarios in the domain and record and restructure how an expert goes about solving such scenarios, recognizing the key steps and sub-steps mentioned along the way; (2) The AI agent dynamically clarifies with the interviewed expert on how tasks that seem to be difficult or major and could or should be decomposed into simpler/smaller ones that may be performed more easily, especially by those having less experience/expertise; and (3) The AI agent creates proposed programming code representing the expert's recommended solution, and asks for verification of such code. These steps are described as being executed by an AI agent but may be executed by the knowledge capture component 210.

The knowledge apply component 220 applies knowledge stored in the knowledge store 240 as follows to solve problems during execution time. The knowledge apply component 220 access the knowledge store 240 and program store 245 to access facts, rules and programs that may be relevant to a particular context and determines which existing program to apply in a given context, or whether a new program needs to be created. The knowledge apply component 220 also determines how to utilize relevant facts and rules to execute such a program consistently and accurately.

The knowledge apply component 220 access information describing programs stored in the program store 245. Each program description represents a signature of the program and includes: (1) metadata/description of the program (or type of program); (2) Inputs required by the program; and (3) Output generated by the program. The knowledge apply component 220 receives information describing a given context in which the knowledge needs to be applied, for example, sensor data, question provided by a user, or a step in an industrial process. The knowledge apply component 220 determines which program stored in the library is applicable in a given context by matching the metadata describing the program and a description of the context. The knowledge apply component 220 may match vector representations of the metadata describing the program and the description of the context using vector distances, for example, using a metric such as cosine similarity to identify the program that is most appropriate for a given context. According to an embodiment, the description of the programs and their metadata is stored in a vector database so that a query based on the context description is performed to identify the most relevant program. If the knowledge apply component 220 identifies a program that matches the given context, the knowledge apply component 220 executes the program with relevant facts and rules where applicable.

According to an embodiment, the knowledge apply component 220 determines whether a program is applicable to a given context by checking whether the context has sufficient information to populate each input parameter of a particular program. The checks whether the context has sufficient information to populate each input parameter of the program. The knowledge apply component 220 matches input data to each parameter of the program matches input data available in the context to each parameter of the program. The knowledge apply component 220 may extract input data relevant to certain program is extracted from the context using the machine learning based language model 250. Accordingly, the knowledge apply component 220 provides the parameters of the program, description of the program, or the entire program along with the context as a structured query input to the machine learning based language model 250 with a request to determine values for each parameter of the program based on the context. The knowledge apply component 220 extracts the values from the response generated by the machine learning based language model 250. If the machine learning based language model 250 is unable to extract values for all the parameters of the program, the knowledge apply component 220 determines that the program is not suitable for the given context and may generate a new program for the given context.

If the knowledge apply component 220 does not find any matching program, for example, of all existing program descriptions are more than a threshold vector distance from the context description, the knowledge apply component 220 creates a new program. The knowledge apply component 220 may create a new program by generating a structured query input for a machine learning based language model 250 describing the context and requesting the machine learning based language model 250 to generate a program to solve the problem described in the context. The structured query input may include all or a subset of the following information (1) Description of the problem from the context. (2) Format of the program to be created, e.g., hierarchical task plan, Python program, etc. (3) Facts and Rules already captured, and (4) Description of existing programs that were determined to be the closest along with reasons why the match failed (e.g., program P1 was the best match but requires 4 parameters and the context only has information for two parameters. Request to generate a program is based on specified parameters. The knowledge apply component 220 extracts the program from the response generated by executing the machine learning based language model 250. According to an embodiment, a generated program is sent to an expert for review. The generation of the process may trigger the knowledge capture phase. The knowledge apply component 220 executes the new program with relevant facts and rules where applicable. The knowledge apply component 220 also stores the new program in the program store 245 for future use. This allows the knowledge store of programs used by AI agents to increase over time.

According to an embodiment, the match of the context with the program description and the parameters may be performed using (1) symbolic match or (2) neural network based probabilistic match. The knowledge apply component 220 makes a decision, whether to perform a symbolic match or a neural network based probabilistic match. If the knowledge apply component 220 determines that the information in the context and the program is highly structured and concrete, the knowledge apply component 220 performs symbolic pattern match. Examples of structured and concrete information include JSON (JavaScript object notation) objects, XML representation, or any structure with a fixed and known schema that stores the information. If the knowledge apply component 220 determines that the information in the context and the program is unstructured, for example, based on natural language description, the knowledge apply component 220 performs neural network based pattern match.

According to an embodiment, system determines a metric (a score) indicating a degree of how structured/unstructured the information is and compares the score against a threshold. If the program is natural-language or largely natural-language-based, the knowledge apply component 220 or the execution engine 239 executes the program through a reasoning mechanism conducted by the machine learning based language model 250. For example, each step of the program is provided in a structured query input to the machine learning based language model 250 with the context and a request to process the step. The description of the step may be provided to a user to take actions based on the step. If the program is symbolic and structured, such as in a programming-language form, the execution is performed through the corresponding processing engine. For example, if the program is a Java program, the program is provided to a Java virtual machine for execution.

According to an embodiment, the agent builder system 150 collects domain specific knowledge from various sources including the internet and stores it using a knowledge representation format. According to an embodiment, the knowledge representation format is a hierarchical tree structure, for example, JSON data structure. Each node in the hierarchical knowledge tree structure represents a category of knowledge or content in the specific domain. For example, the hierarchical knowledge tree structure may be built for knowledge in semiconductor field. Accordingly, in the hierarchical knowledge tree structure, higher level node N1 represents a broad category (e.g., etching technique for semiconductor), below node N1 in the tree are other nodes N2, N3, that represent subcategories (e.g., N2 is dry etching techniques and N3 is wet etching techniques in semiconductor) and there are nodes below node N2, N3 in the tree that are further sub-categories, for example, below node N2 there is node N4, N5 that represent specific type of dry etching techniques such as reactive ion etching (RIE) technique, etc.

According to an embodiment, the knowledge representation format is a hierarchical tree structure, for example, JSON data structure. Each node in the hierarchical knowledge tree structure represents a category of knowledge or content in the specific domain. For example, the hierarchical knowledge tree structure may be built for knowledge in semiconductor field. Accordingly, in the hierarchical knowledge tree structure, higher level node N1 represents a broad category (e.g., etching technique for semiconductor), below node N1 in the tree are other nodes N2, N3, that represent subcategories (e.g., N2 is dry etching techniques and N3 is wet etching techniques in semiconductor) and there are nodes below node N2, N3 in the tree that are further sub-categories, for example, below node N2 there is node N4, N5 that represent specific type of dry etching techniques such as reactive ion etching (RIE) technique, etc.

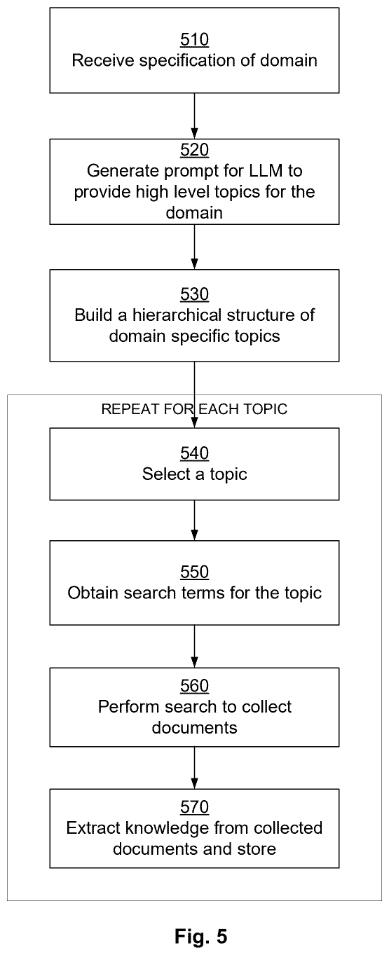

FIG. 5 illustrates the overall process for collecting domain specific knowledge for a domain-expert AI agent, according to an embodiment of the invention. The steps illustrated in the process may be performed in an order different from that indicated in FIG. 3. Furthermore, the steps are indicated as being performed by a system, for example, the agent builder system 150 and may be performed by the appropriate module as shown in FIG. 2 and described in connection with description of FIG. 2.

The knowledge capture component 210 of the agent builder system 150 receives 510 a specification of the domain. The specification of the domain may be provided as natural language description. For example, the domain may be “semiconductor manufacturing and design,” or “maritime industry for tasks such as trajectory planning, risk assessment, and compliance.”

The knowledge capture component 210 generates a prompt, i.e., a structured query input for the machine learning based language model 250, the prompt describing the domain and requesting the machine learning based language model 250 to identify a hierarchy of topics that capture the knowledge for the domain. The hierarchy of topics is build 530 by extracting the topics from the response generated by executing the machine learning based language model 250. According to an embodiment, the knowledge capture component 210 may iteratively interact with the machine learning based language model 250 to build the hierarchy of topics for a domain. For example, the knowledge capture component 210 may initially request the machine learning based language model 250 to provide a set of high-level topics for the domain. The knowledge capture component 210 may subsequently iterate through each topic to request sub-topics for that topic from the machine learning based language model 250. The knowledge capture component 210 repeats this process until a predetermined depth of hierarchy of topics is obtained. A topic or a sub-topic in the hierarchy is also referred to herein as a category.

The knowledge capture component 210 extracts knowledge for the domain by retrieving documents for each topic. The knowledge capture component 210 repeats the following steps 540, 550, 560, and 570 for each topic of the hierarchy. The knowledge capture component 210 selects 540 a topic from the hierarchy. The knowledge capture component 210 obtains 550 search terms for the topic. The search terms may be generated when the hierarchy is being built in step 530 or may be generated while populating the topic with knowledge. The knowledge capture component 210 may ask the machine learning based language model 250 to provide the search terms that characterize the knowledge for each topic.

The knowledge capture component 210 performs 560 search using the search terms for the topic to collect documents for the topic. The knowledge capture component 210 extracts 570 knowledge from each document and stores in the knowledge store 240 or program store 245.

According to an embodiment, the structure of knowledge representation in each category comprises a tuple of at least three elements, each represented using natural language: (1) Positive condition element indicating when to apply the knowledge (e.g., represented as a field “when_to_apply” in the JSON structure of the category.) (2) a negative condition element indicating when not to apply the knowledge (e.g., represented as a field “when_should_not_apply” in the JSON structure of the category.) (3) A detailed knowledge element representing details of the knowledge (e.g., represented as a field “detailed_knowledge” in the JSON structure of the category.)

Following is an example of a tuple for storing knowledge related to Reactive Ion Etching category within the domain specific knowledge for semiconductor domain.

```
{
  “when_to_apply”: “When etching hBN structure for photonic applications
  where precise control of feature dimensions is required.”
  “when_should_not_apply”: “When surface rougness and edge-induced
  defects must be minimized to the greatest extent.”
  “detailed_knowledge”: “Fluorine-based RIE can achieve the desired etch
  depth rapidly comparted to chlorine-based RIE, but it may introduce
  sidewall rougness known as microtrenching, which affects photonic
  properties.”
}
```

According to an embodiment, the system extracts the following information from various knowledge sources for incorporating in facts and rules knowledge stores. (1) Key concepts' names and synonyms (2) Key concepts' definitions (3) Formulas (4) Conventions/Typical Considerations (5) (Subjective) Expert Opinions on how to assess/evaluate/judge the goodness of some outcomes, and (6) Exceptions. The system stores in the program store steps for significant tasks in the domain that need to be performed precisely.

According to an embodiment, the system quantifies the amount of knowledge of an agent by simulating an interview with the agent. The system collects a set of questions to test/evaluate the knowledge of the domain-expert agent. The questions may be obtained from users who are domain experts. Alternatively the questions may be synthesized using a large language model. Alternatively, the system may acquire the questions also from the internet by performing various searches. The set of domain specific questions is used by the system to compare two models M1 and M2 to determine which domain-expert agent is more advanced or is suitable for being deployed in a domain specific environment. According to an embodiment, the system uses the set of domain-specific questions to evaluate a domain-expert agent being built to determine whether the knowledge of the domain-expert agent has reached a sufficient threshold. The system provides each question to the domain-expert agent and obtains the answer from the domain-expert agent. The system evaluates the answers, for example, by providing the answers to a user who is a domain-expert or by providing to a large language model. The system scores each answer and aggregates the scores over the answers to determine an aggregate score for the domain-expert agent. The aggregate score represents a measure of the amount of domain specific knowledge of the domain-expert agent.

If the system determines based on the set of questions that the knowledge of the domain-expert agent has reached a sufficient threshold, the system may deploy the domain-expert agent in a production environment. If the system determines based on the set of questions that the knowledge of the domain-expert agent has not reached a sufficient threshold, the system continues building the knowledge and expertise of the domain-expert agent and repeats the process until the domain-expert agent reaches the required threshold of knowledge.

According to an embodiment, the system follows the following process to build domain specific knowledge for an agent to transform the agent to a domain-expert agent. The system may incorporate public knowledge by searching and downloading documents from various knowledge sources including the internet or digital libraries.

According to an embodiment, the system builds the hierarchy of categories for a domain as follows. The system may interact with a machine learning based language model 250 to build the hierarchy of categories. The system generates a prompt for asking to the machine learning based language model 250 to determine one or more broad categories and then recursively asks the machine learning based language model 250 for subcategories within each category. The system asks a large language model about the field for the initial set of categories. The system builds the hierarchy by interactively asking machine learning based language model 250. The system generates a prompt to ask high level categories/topics in a field, then recursively (or iteratively) ask for sub-categories within each category.

According to an embodiment, the system considers a field as the root, and then ask LLMs to generate all the subfields of that field. From these subfields, the system generates all possible related keywords. The system therefore obtains pairs of (subfield, keyword). The system searches using expressions such as “{keyword}in context of {subfield}” to make the search more specific and effective.

The system converts the knowledge acquired from the documents collected to the tuple format for example, by generating the various fields including the “when to apply” field, the “when not to apply” field, and the “detailed knowledge” field. The number of tuples within a category may depend on the amount of related knowledge in the documents. The system may collect different type of knowledge from books vs. research papers. The system acquires foundational and well-known knowledge from books and acquires state-of-the-art knowledge with solid analysis and experiments from research papers. The system may use the error analysis in the papers to generate fields of the tuples representing what to not do. The system may generate the tuples of “when to apply”, “when not to apply”, “detailed knowledge” simultaneously in a single prompt.

The system converts the knowledge stored in the above tuple format to facts, rules and heuristics for incorporating in the agent. From the input problems, the agents search for appropriate knowledge by looking at “when to apply” and “when not to apply”, and all the appropriate knowledge is fed to the prompt generated for an LLM for better problem-solving.

The system further extract programs from this knowledge obtained from documents. The system analyzes all the problems appearing in the documents and checks if the document includes steps for solutions. If the document describes the process, the system summarizes the process and uses an LLM to generate a step-by-step solution.

According to an embodiment, the system uses a list of evaluation criteria for evaluation of the domain-expert agent.

Clarity and Directness (C&D): This criterion involves using simple and straightforward language to ensure that the answer is easily understood. This means avoiding unnecessary jargon or technical terms that could confuse the reader. It also requires directly addressing the question or topic at hand in each sentence, maintaining a focus on the main points. Organizing information with bullet points or numbered lists can further enhance readability and make key points more accessible.

Practicality and Immediate Usability (PIU): Practicality and immediate usability involve providing recommendations that are both practical and easy to implement. This means focusing on clear, actionable steps rather than theoretical explanations, ensuring that the guidance is directly applicable to real-world situations. Recommendations should be realistic and suitable to the specific context, making them immediately usable and relevant to the audience's needs.

Efficiency and Brevity (E&B): Efficiency and brevity involve eliminating redundant information and combining related points to avoid verbosity. The goal is to keep the information concise while still covering all necessary details, ensuring that the message is clear and to the point without unnecessary elaboration.

Logical Flow and Coherence (LFC): Logical flow and coherence involve arranging points in a clear, logical order to make the answer easy to follow. This includes grouping related points together under clear categories, enhancing the overall coherence, and ensuring that the user can easily understand the progression of ideas.

Expert-to-Expert Communication (EEC): Expert-to-expert communication involves tailoring responses as instructions or directions that an experienced engineer would give to another engineer in the same role but with less experience. This ensures that the conversation is part of a problem-solving process, focusing on advanced concepts and practical guidance without delving into overly basic explanations that would be unnecessary for an expert audience.

Use of Examples and Specificity (UES): The use of examples and specificity involves providing examples only when they add significant value to the explanation. Ensure that comparisons are directly related to the point being made and are concise. Introduce technical terms only if they are essential to the discussion, and offer concise explanations for these terms only if requested to maintain clarity and relevance.

According to an embodiment, the system collaborates with domain experts to build the domain specific evaluation criteria. Following are details of step A1 (training of Agent. There are two different embodiment described for synthesizing knowledge for agent using LLM.

According an embodiment, the system receives as input the role of the expert that the system needs to create. The system analyzes the role with the necessary skills/knowledge and the level of each knowledge field, including the breadth of knowledge and the depth of knowledge. For example, an engineer needs to have math knowledge, but doesn't need to be broad and in-depth like a physicist. Lowest is 1 and highest is 5. The system performs skill profiling. For example: Skill for an engineer in Semiconductors. (1) Processing skill: High-Q Oscillator Design. Amount: 5/5; Depth 5/5. (2) Processing skill: Phase Noise Reduction Techniques. Amount: 5/5; Depth 5/5. (3) Processing skill: Thin-Film Deposition Techniques (Sputtering, CVD, ALD). Amount: 5/5; Depth 5/5. (4) Processing skill: Sputtering Target Optimization. Amount: 4/5; Depth 4/5. (5) Processing skill: Device Characterization and Failure Analysis. Amount: 4/5; Depth 4/5. (6) Processing skill: Process Control and Statistical Analysis (SPC, DOE). Amount: 4/5; Depth 4/5; and so on. For each knowledge field, the system generates the necessary knowledge in the defined level of breadth and depth.

According to an embodiment, the system performs the following steps to perform step A1. (1) The system receives as input, user profiles of example domain experts for the domain, for example, resumes of an ideal candidates or job description for domain experts for the domain. (2) The system analyzes the user profiles descriptions, for example, the resumes and job descriptions to parse to a pre-defined form. (3) The system extract the necessary skills/knowledge and the equivalent level. (4) For each knowledge field, the system generates the necessary knowledge in the defined level of breadth and depth.

According to an embodiment, the system provides the necessary input in a prompt to the LLM, for example, the role of expert agent that needs to create or ideal candidate's resume. An example of response generated by the LLM is as follows.

```
  {
    “Sputtering Target Optimization”: {
      “Optimize Material Composition”: “”,
      “Improve Uniformity in Sputtering”: “”,
      “Enhance Target Durability”: “”
    },
    “High-Q Oscillator Design”: {
      “Reduce Phase Noise”: “”,
      “Optimize Resonator Geometry”: “”,
      “Improve Frequency Stability”: “”
    },
    “EDA Tools”: {
      “Use Cadence Virtuoso for IC Design”: “”,
      “Simulate Circuits with Cadence Spectre”: “”,
      “Perform Digital Synthesis with Synopsys Design Compiler”:
“”,
      “Conduct Thermal Simulations with COMSOL”: “”,
      “Analyze RF Designs with HFSS”: “”
    },
  ...
  }
```

The step A2 injects the knowledge into the agent using the techniques described herein. The implementation of step A3 is similar to the step M3 as disclosed herein. The step A3 evaluates the agent using the techniques described herein.

### Applications

The techniques disclosed herein can be applied to various applications, for example, as follows.

Task optimization: The controlling agent learns to prompt or guide the LLM for optimal performance on specific tasks. For task optimization, the system asks the agent to help users on a task, such as write frontend code to create a website for a system following a given design. Conventionally, a software engineer needs to design the code structure and prompt LLM to write all the functions that the user needs manually. When LLM writes code, the software engineer needs to continuously refine the prompts to get the expected results. According to an embodiment, the domain-expert AI agent writes the prompts by itself and uses LLMs as a tool to help users finish the task. As a result, a user does not have to manually prompt the LLMs, the agent can adjust the prompt/conversation by itself, thereby reducing workload for users, and generating more accurate results from the agent, and improving the overall efficiency of execution.

Adaptive interaction: A domain-expert agent dynamically adjusts its interaction with the LLM based on task requirements or environmental feedback. For different tasks and environments, the agent adjusts the prompts it writes for LLMs to finish the tasks in the best way. For example, for different documents, the agent can prompt the LLMs to support the writer in drafting the document according to various domain specific conventions and rules.

Performance studies were performed to compare domain-expert agents generated using the techniques disclosed herein with conventional agents. The agent builder system 150 that was tested is referred to herein as DANA. For each problem, ten solutions were generated from each AI system and the percentage of solutions being correct calculated to calculate an Average Accuracy score for the AI system. Following table shows the average accuracy of different systems compared with the agent builder system 150 referred to as DANA. The following table shows that the results of DANA, i.e., the techniques disclosed according to various embodiments have higher average accuracy consistently across various difficulty levels. This is so because of the use of domain specific knowledge.

| | | LlamaIndex | LangChain | OpenAI | |
|---|---|---|---|---|---|
| Difficulty Level | #Qs | RAG | ReAct | Assistant | DANA |
| 0-RETRIEVE | 56 | 71% | 85% | 49% | 95% |
| 1-COMPARE | 23 | 83% | 90% | 46% | 90% |
| 2-CALC-CHANGE | 9 | 78% | 69% | 36% | 93% |
| 3-CALC-COMPLEX | 43 | 31% | 88% | 40% | 100% |
| 4-CALC-AND-JUDGE | 10 | 14% | 60% | 14% | 94% |
| 5-EXPLAIN-FACTORS | 2 | 70% | 70% | 50% | 100% |
| 6-OTHER-ADVANCED | 1 | 43% | 37% | 46% | 89% |

From the same ten solutions generated for each problem from each AI system, a consistency score was assigned to that solution set based on whether those solutions were consistently correct or incorrect per certain ground truths, with a 100%-consistency score for an all-correct or all-incorrect solution set, and a 0%-consistency score for a half-correct-and-half-incorrect solution set. The consistency score is calculated as twice the absolute difference between 50% and the proportion of the ten solutions being correct. Performing such scoring across multiple cases and taking an average was used to determine an Average Consistency score for the AI system. The following table shows the results of average consistency across various difficulty levels for various systems compared with DANA. The following table shows that the results of DANA, i.e., the techniques disclosed according to various embodiments have higher average consistency across various difficulty levels. This is so because of the use of symbolic processing combined with machine learning model based processing of DANA.

| | | LlamaIndex | LangChain | OpenAI | |
|---|---|---|---|---|---|
| Difficulty Level | #Qs | RAG | ReAct | Assistant | DANA |
| 0-RETRIEVE | 56 | 96% | 86% | 76% | 96% |
| 1-COMPARE | 23 | 90% | 91% | 65% | 97% |
| 2-CALC-CHANGE | 9 | 100% | 78% | 87% | 87% |
| 3-CALC-COMPLEX | 43 | 87% | 84% | 73% | 100% |
| 4-CALC-AND-JUDGE | 10 | 88% | 68% | 72% | 92% |
| 5-EXPLAIN-FACTORS | 2 | 60% | 60% | 100% | 100% |
| 6-OTHER-ADVANCED | 7 | 100% | 66% | 77% | 94% |

The agent builder system 150 was used to generate a high level application of DANA in a physical-industry workflow which requires that AI provide highly precise analyses and recommendations. The particular use case was semiconductor etching recipe formulation.

The semiconductor industry has many complex design and manufacturing processes—e.g., design rule checking, layout generation, photolithography, etching, deposition, ion implantation, gate oxide formation, insulation, bonding, etc.—which need careful calibration to achieve optimal technical and economic outcomes. Etching recipe formulation is one such intricate task: it involves dozens of machine parameters that affect key physical operations and chemical reactions. A recipe lacking in rigor would result in inefficient cycle times or expensive reliability and quality problems such as etch rate anomalies, mask erosion, pattern distortion, plasma instability and non-uniformity, which negatively impact yield. Hence, the formulation of feasible and optimal etching recipes requires deep domain expertise and time-consuming expert analyses. There is consequently a great need for scaling up and making more available the knowledge of scarce experts in this domain.

DANA achieves superior consistency due to more explicit and greater assigned responsibility to symbolic elements in organizing domain-specific knowledge, and in structuring and executing problem-solving programs. The use of symbolic structures and their more deterministic operations significantly reduced the variability in individual processing step results and in how such results are aggregated or consolidated during an entire program's execution.

First-class treatment of domain-specific knowledge, both in the facts-and-rules form and the program form, results in DANA's superior consistency and accuracy in complex problem-solving. Such knowledge integration results in success in industrial AI, for example, for the semiconductor domain. The domain-expert agents developed using the techniques disclosed herein achieved following advantages.
(1) Reduced Critical Errors: DANA helps reduce critical errors in applications in high-stakes fields such as manufacturing and healthcare that greatly need such consistency and accuracy to mitigate the risk of costly or dangerous accidents that can occur with purely data-driven approaches using machine learning based language models that are non-deterministic in nature. The user of symbolic processing combined with stochastic processing of machine learning based models reduces impact of non-determinism of machine learning based language models and reduces critical errors.
(2) Improved Interpretability: DANA uses domain-specific knowledge representation to make AI decision-making processes more explainable, transparent and interpretable; and
(3) Faster Deployment: DANA leverages existing domain expertise to accelerate the deployment of AI systems in new industrial contexts, reducing the need for extensive data collection and model training to achieve comparable problem-solving quality.

The domain-expert agents built using the techniques disclosed herein such as DANA provides following benefits to industrial use of artificial intelligence.
(1) Scalable Expertise: DANA performs automated knowledge capture mechanisms that allow industries to scale their AI capabilities more efficiently, capturing and operationalizing the knowledge of multiple experts;
(2) Continuous Learning: domain-expert agents built using DANA at as automated systems with active monitoring and evaluation that could potentially update their knowledge bases in real-time, allowing industrial AI to adapt quickly to new information or changing conditions; and
(3) Customization and Specialization: the various DANA variants can be used for tailoring AI systems to specific industrial needs.

Furthermore, the system disclosed according to various embodiments solves various technical problems of conventional techniques. The system combines the benefits of symbolic processing with benefits of machine learning based language models to alleviate the problems of each. For example, several problems require natural language processing, for example, to execute natural language based programs, process natural language based facts and rules, and so on. The system uses machine learning based language models to process such computations. However, there are several problems that are better solved using symbolic processing since the problems are structured and have specific solutions that may be solved using symbolic programs such as programs specified using programming languages such as Java or python. The system uses symbolic processing to solve such problems, thereby minimizing use of machine learning based language model for solving problems. This alleviates the problems of non-deterministic nature of machine learning based language model and other issues such as lower accuracy and precision when solving certain types of problems, for example, problems involving numeric computations. Accordingly, the system utilizes symbolic processing wherever possible and utilizes machine learning based language model for solving remaining problems where symbolic processing is not possible, thereby improving the accuracy of processing while utilizing machine learning based language model for processing.

Furthermore, processing using machine learning based language model 250 is computationally expensive and utilizes large amount of processing and memory resources. Also, typically machine learning based language model 250 are executed by external systems as web services and are invoked over the network, thereby consuming network resources as well. Since the system disclosed offloads several computations to symbolic processing, the system improves the resource utilization and computational efficiency as well as efficient utilization of memory resources. Further, typical symbolic processing modules do not require as much memory as machine learning based language model 250 and can be performed locally by the agent builder system 150, thereby reducing network utilization since no network communication is required while performing the processing locally at the agent builder system 150. Therefore the system as disclosed according to various embodiments improves the efficiency of execution and resource utilization of computing resources, memory resources, and network resources. The machine learning based language model 250 may also be referred to herein as an LLM.

Furthermore, the system disclosed provides improved latency of computations since significant amount of knowledge is precomputed and packaged with the domain-expert agent. Systems that do not precompute such knowledge need to perform the processing at execution time, for example, after the user has provided a natural language question. Systems that need to perform Internet searches, access documents and process them, generate programs after receiving a question from the user are likely to take significantly longer to provide a response compared to the system as disclosed that has significant amount of knowledge and programs precomputed and ready to execute. As a result, the system as disclosed provides improved user experience and lower latency while providing responses to questions from users or requests received from other systems.

Another benefit of the system as disclosed is that the knowledge is collected by the system in a knowledge capture phase that is separate from the knowledge apply phase. The systems that apply the knowledge at inference time are likely running other applications, for example, in an industrial setting and do not have large amount of computational, memory, and networking resource available for dedicating to the domain-expert agent. In contrast, if the knowledge capture phase is executed separately by the agent builder system 150, large servers can be dedicated to collection of the knowledge and the process executed during off hours that are different from peak hours when computational resources are busy for other tasks. This results in improving the performance of machines executing the domain-expert agents since the knowledge collection workload is offloaded to the agent builder system 150 and is performed at any time when the system load is less. Furthermore, the agent builder system 150 performs the knowledge collection once and deploys the collected knowledge to multiple domain-expert agent instances. Accordingly, the collected knowledge is reused across multiple deployment. In contrast, systems that collect knowledge at runtime upon deployment of domain-expert agent need to fetch the same knowledge independently for each domain expert instance since they are not preloaded with the knowledge. Accordingly, if N instances of domain-expert agents are deployed and need to perform the same computation, for example, search for documents on the Internet, processing of the documents for knowledge extraction, generation of programs, and so on, the overhead of the computation is N*P where P is the processing performed by each instance. In contrast, the agent builder system 150 performs the computation once taking P amount of processing and is therefore efficient by a factor of N.

Accordingly, the system as disclosed offers several technical improvements compared to conventional techniques.

### Computer Architecture

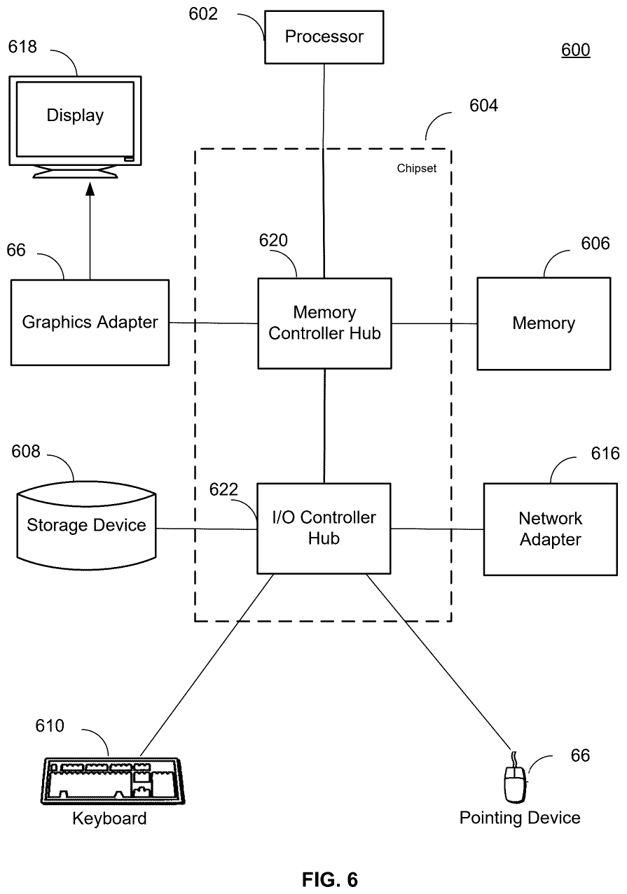

FIG. 6 is a high-level block diagram illustrating an example system, in accordance with an embodiment. The computer 600 includes at least one processor 602 coupled to a chipset 604. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

The storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, or other type of pointing device, and is used in combination with the keyboard 610 to input data into the computer system 600. The graphics adapter 612 displays images and other information on the display 618. The network adapter 616 couples the computer system 600 to one or more computer networks.

The computer 600 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 608, loaded into the memory 606, and executed by the processor 602. The types of computers 600 used can vary depending upon the embodiment and requirements. For example, a computer may lack displays, keyboards, and/or other devices shown in FIG. 6.

### ADDITIONAL CONSIDERATIONS

It is to be understood that the Figures and descriptions of the present invention have been simplified to illustrate elements that are relevant for a clear understanding of the present invention, while eliminating, for the purpose of clarity, many other elements found in a typical distributed system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for displaying charts using a distortion region through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for building a domain-expert agent (AI agent), comprising:
receiving information describing a domain for generating a domain-expert agent;
generating a hierarchy of topics for the domain, comprising:
generating one or more structured query inputs describing the domain and requesting a machine learning based language model to generate topics for the domain, each topic associated with a set of search terms, and
receiving topics and associated sets of search terms in one or more responses generated by executing the machine learning based language model;
building a knowledge store for the domain, comprising, for each topic of the hierarchy of topics for the domain, identifying facts related to the topics, each fact stored as (1) symbolic representation of knowledge or (2) natural language representation of knowledge;
for at least one or more topics generating one or more programs, each program comprising instructions for performing specific procedures to solve domain specific problems for the domain, each program stored as (1) symbolic program or (2) natural language program;
evaluating the knowledge store to determine an expertise level for a domain-expert agent using the knowledge store;
responsive to determining that the knowledge store has at least a threshold amount of knowledge, creating a package for deploying a domain-expert agent, the package comprising the knowledge store; and
deploying the domain-expert agent for execution, wherein the domain-expert agent uses domain knowledge from the knowledge store in conjunction with a machine learning language model for solving domain specific problems for the domain.

2. The computer-implemented method of claim 1, further comprising:
receiving, by a domain-expert agent, a context for solving a domain specific problem;
accessing one or more tuples storing facts related to the context from the knowledge store of the domain-expert agent;
generating a structured query input based on the context and the one or more tuples relevant to the context; and
extracting a solution to the domain specific problem from a response obtained by executing the machine learning based language model.

3. The computer-implemented method of claim 1, further comprising:
receiving, by a domain-expert agent, a context for solving a domain specific problem; and
determining whether a program from the knowledge store can be used for solving the domain specific problem by comparing a description of the context with a description of one or more programs stored in the knowledge store.

4. The computer-implemented method of claim 3, wherein determining whether a program from the knowledge store can be used for solving the domain specific problem comprises:
for each program, storing vector representations of description of the program in a vector database;
determining a vector representation of the context; and
for each program, determining a vector distance between the vector representation of the context and vector representation of description of the program stored in the vector database.

5. The computer-implemented method of claim 3, wherein the program comprises a set of input parameters, wherein determining whether a program from the knowledge store can be used for solving the domain specific problem further comprises, determining whether the context is able to provide values for each input parameter of the program.

6. The computer-implemented method of claim 3, further comprising:
determining that a particular program from the knowledge store can be used for solving the domain specific problem; and
responsive to determining that the particular program from the knowledge store can be used for solving the domain specific problem, executing the particular program to solve the domain specific problem.

7. The computer-implemented method of claim 3, further comprising:
determining that none of the programs of the knowledge store can be used for solving the domain specific problem;
responsive to determining that that none of the programs of the knowledge store can be used for solving the domain specific problem, generating a new program for solving the domain specific problem;
storing the new program in the knowledge store; and
executing the new program to solve the domain specific problem.

8. The computer-implemented method of claim 6, wherein generating a program comprises:
generating a structured query input describing the context and requesting the machine learning based language model to generate a program to solve a domain specific problem described in the context;
providing the structured query input to the machine learning based language model; and
extracting the program from a response generated by executing the machine learning based language model.

9. The computer-implemented method of claim 1, wherein identifying a fact for storing in the knowledge store comprises one or more of:
obtaining the fact from a domain expert user by interacting with the domain expert user by a chatbot; or
performing a search for documents related to a topic based on a set of search terms associated with the topic to obtain a set of documents and processing the set of documents to extract facts for the topic.

10. The computer-implemented method of claim 1, further comprising:
receiving, by a domain-expert agent, a context for solving a domain specific problem;
determining whether the information available in the context is structured or unstructured;
responsive to determining that the information available in the context is structured, using a symbolic program and symbolic facts for solving the domain specific problem; and
responsive to determining that the information available in the context is unstructured, using a natural language program and natural language facts for solving the domain specific problem.

11. The computer-implemented method of claim 1, wherein evaluating the knowledge store comprises:
receiving information describing user profiles of domain experts for the domain;
generating a plurality of domain specific questions for evaluating a domain-expert agent based on the user profiles;
for each of the plurality of domain specific questions, using a test domain-expert agent using the knowledge store to solve the domain specific question; and
determining an aggregate metric for evaluating the expertise level of the test domain-expert agent based on responses to the plurality of domain specific questions generated by the test domain-expert agent.

12. A computer-readable non-transitory memory storing instructions that when executed by one or more computer processors cause the one or more computer processors to perform steps of a method for solving domain specific problems specified using natural language requests, the steps comprising:
receiving information describing a domain for generating a domain-expert agent;
generating a hierarchy of topics for the domain, comprising:
generating one or more structured query inputs describing the domain and requesting a machine learning based language model to generate topics for the domain, each topic associated with a set of search terms, and
receiving topics and associated sets of search terms in one or more responses generated by executing the machine learning based language model;
building a knowledge store for the domain, comprising, for each topic of the hierarchy of topics for the domain, identifying facts related to the topics, each fact stored as (1) symbolic representation of knowledge or (2) natural language representation of knowledge;
for at least one or more topics generating one or more programs, each program comprising instructions for performing specific procedures to solve domain specific problems for the domain, each program stored as (1) symbolic program or (2) natural language program;
evaluating the knowledge store to determine an expertise level for a domain-expert agent using the knowledge store;
responsive to determining that the knowledge store has at least a threshold amount of knowledge, creating a package for deploying a domain-expert agent, the package comprising the knowledge store; and
deploying the domain-expert agent for execution, wherein the domain-expert agent uses domain knowledge from the knowledge store in conjunction with a machine learning language model for solving domain specific problems for the domain.

13. The computer-readable non-transitory memory of claim 12, wherein the instructions further cause the one or more computer processors to perform steps comprising:
receiving, by a domain-expert agent, a context for solving a domain specific problem;
accessing one or more tuples storing facts related to the context from the knowledge store of the domain-expert agent;
generating a structured query input based on the context and the one or more tuples relevant to the context; and
extracting a solution to the domain specific problem from a response obtained by executing the machine learning based language model.

14. The computer-readable non-transitory memory of claim 12, wherein the instructions further cause the one or more computer processors to perform steps comprising:
receiving, by a domain-expert agent, a context for solving a domain specific problem; and
determining whether a program from the knowledge store can be used for solving the domain specific problem by comparing a description of the context with a description of one or more programs stored in the knowledge store.

15. The computer-readable non-transitory memory of claim 14, wherein determining whether a program from the knowledge store can be used for solving the domain specific problem comprises:
for each program, storing vector representations of description of the program in a vector database;
determining a vector representation of the context; and
for each program, determining a vector distance between the vector representation of the context and vector representation of description of the program stored in the vector database.

16. The computer-readable non-transitory memory of claim 14, wherein the instructions further cause the one or more computer processors to perform steps comprising:
determining that a particular program from the knowledge store can be used for solving the domain specific problem; and
responsive to determining that the particular program from the knowledge store can be used for solving the domain specific problem, executing the particular program to solve the domain specific problem.

17. The computer-readable non-transitory memory of claim 14, wherein the instructions further cause the one or more computer processors to perform steps comprising:
determining that none of the programs of the knowledge store can be used for solving the domain specific problem;
responsive to determining that that none of the programs of the knowledge store can be used for solving the domain specific problem, generating a new program for solving the domain specific problem;
storing the new program in the knowledge store; and
executing the new program to solve the domain specific problem.

18. The computer-readable non-transitory memory of claim 16, wherein instructions for generating a program cause the one or more computer processors to perform steps comprising:
generating a structured query input describing the context and requesting the machine learning based language model to generate a program to solve a domain specific problem described in the context;
providing the structured query input to the machine learning based language model; and
extracting the program from a response generated by executing the machine learning based language model.

19. A computer system comprising:
one or more computer processors; and
a computer-readable non-transitory memory storing instructions that when executed by the one or more computer processors cause the one or more computer processors to perform steps of a method for solving domain specific problems specified using natural language requests, the steps comprising:
receiving information describing a domain for generating a domain-expert agent;
generating a hierarchy of topics for the domain, comprising:
generating one or more structured query inputs describing the domain and requesting a machine learning based language model to generate topics for the domain, each topic associated with a set of search terms, and
receiving topics and associated sets of search terms in one or more responses generated by executing the machine learning based language model;
building a knowledge store for the domain, comprising, for each topic of the hierarchy of topics for the domain, identifying facts related to the topics, each fact stored as (1) symbolic representation of knowledge or (2) natural language representation of knowledge;
for at least one or more topics generating one or more programs, each program comprising instructions for performing specific procedures to solve domain specific problems for the domain, each program stored as (1) symbolic program or (2) natural language program;
evaluating the knowledge store to determine an expertise level for a domain-expert agent using the knowledge store;
responsive to determining that the knowledge store has at least a threshold amount of knowledge, creating a package for deploying a domain-expert agent, the package comprising the knowledge store; and
deploying the domain-expert agent for execution, wherein the domain-expert agent uses domain knowledge from the knowledge store in conjunction with a machine learning language model for solving domain specific problems for the domain.

20. The computer system of claim 19, wherein the instructions further cause the one or more computer processors to perform steps comprising:
receiving, by a domain-expert agent, a context for solving a domain specific problem;
accessing one or more tuples storing facts related to the context from the knowledge store of the domain-expert agent;
generating a structured query input based on the context and the one or more tuples relevant to the context; and
extracting a solution to the domain specific problem from a response obtained by executing the machine learning based language model.
